(19) United States
(12) Patent Application Publication
(10) Pub. No.: US 2026/0109591 A1
(43) Pub. Date: Apr. 23, 2026

(54) BEVERAGE SERVER

(71) Applicant: Suntory Holdings Limited, Osaka-shi, Osaka (JP)

(72) Inventors: Takashi Harada, Kawasaki-shi, Kanagawa (JP); Akira Yoshihiro, Kawasaki-shi, Kanagawa (JP); Takashi Kudo, Kawasaki-shi, Kanagawa (JP); Ayumu Kitagaki, Tokyo (JP); Mihoko Nakajima, Kawasaki-shi, Kanagawa (JP); Ryohei Mano, Tokyo (JP)

(73) Assignee: Suntory Holdings Limited, Osaka-shi, Osaka (JP)

(21) Appl. No.: 19/117,730

(22) PCT Filed: Sep. 20, 2023
(86) PCT No.: PCT/JP2023/034038

§ 371 Date: Apr. 2, 2025

(30) Foreign Application Priority Data
Oct. 7, 2022 (JP) 2022-162488

(51) Int. Cl. B67D 1/12; B67D 1/00; B67D 1/08

(52) U.S. Cl. CPC B67D 1/1295; B67D 1/0085; B67D 1/0882; B67D 2001/0093; B67D 2001/0097

(57) ABSTRACT

A beverage server able to accurately customize concentrations of a nonalcoholic beverage and alcoholic beverage. The beverage server 10 has beverage dispensing parts 14, 18 having at least one of first discharge nozzles 16b, 20b or a second discharge nozzle 16c among first discharge nozzles 16b, 20b, a second discharge nozzle 16c, and water discharge nozzle 16a and dispensing a beverage and a control device 82 making a first flow jet pump 58 and first flow regulator 60 operate together so as to enable control of a discharge rate of the first liquid supplied to the first discharge nozzles 16b, 20b and making a second flow jet pump 74 and second flow regulator 76 operate together so as to enable control of a discharge amount of the second liquid supplied to the second discharge nozzle 16c, the beverage server able to adjust an alcohol concentration of the beverage dispensed from the first beverage dispensing part 14.

### FIELD

The present application relates to a beverage server.

### BACKGROUND

In recent years, the way people think of beverages has become more diversified. For example, a “sober curious” lifestyle not overly indulging in alcoholic beverages has been proposed. Further, even among people who like to drink alcoholic beverages, there has been a rising tendency for them to choose low alcohol beverages or nonalcoholic beverages depending on their feelings or conditions at the time. In this way, there is a growing need for different alcohol concentrations and levels of flavor of beverages provided at food outlets etc. Provision of beverages customized in concentration has been sought.

For example, PTL 1 discloses a beverage supply apparatus supplying a liquid stock solution and carbonated water for forming a carbonated beverage to a single cup, characterized by being independently provided with a liquid stock solution nozzle by which the liquid stock solution is supplied and a carbonated water nozzle by which the carbonated water is supplied. However, such a beverage supply apparatus has as its object to improve the mixed state of a beverage such as suppressing the occurrence of foaming and suppressing a drop in gas volume and does not have as its object to accurately customize the alcohol concentration of the beverage. Further, even if trying to provide beverages of diverse alcohol concentrations by such a beverage supply apparatus, it would be necessary to increase the number of nozzles for dispensing the beverage and, furthermore, prepare a large number of beverage tanks with different alcohol concentrations, but the beverage supply apparatus would become large in size and the installation space would have to be enlarged, so it would be difficult to install it in a normal food outlet etc.

### CITATIONS LIST

### Patent Literature

[PTL 1] Japanese Unexamined Patent Publication No. 2003-137396

### SUMMARY

### Technical Problem

The present application has as its object, considering the above such issue, to provide a beverage server able to accurately customize the concentration of a nonalcoholic beverage and alcoholic beverage.

### Solution to Problem

One aspect of the present disclosure is a beverage server for providing a beverage comprising a beverage dispensing part having at least one of a first discharge nozzle and a second discharge nozzle among a first discharge nozzle, second discharge nozzle, and third discharge nozzle and dispensing a beverage, a first pump connected with a first tank and pumping a first liquid stored in the first tank, a first supply pipe connecting the first tank and the first discharge nozzle and having the first liquid pumped from the first tank flowing through it, a first adjustment mechanism arranged in the middle of the first supply pipe and able to adjust a flow rate of the first liquid supplied to the first discharge nozzle, a second pump connected with a second tank and pumping a second liquid stored in the second tank, a second supply pipe connecting the second tank and the second discharge nozzle and having the second liquid pumped from the second tank flowing through it, a second adjustment mechanism arranged in the middle of the second supply pipe and able to adjust a flow rate of the second liquid supplied to the second discharge nozzle, a third supply pipe connecting a third liquid supply part for supplying a third liquid and a third discharge nozzle and having the third liquid from the third liquid supply part flowing through it, and a control device making the first pump and the first adjustment mechanism operate together so as to enable control of a discharge rate of the first liquid supplied to the first discharge nozzle and making the second pump and the second adjustment mechanism operate together so as to enable control of a discharge rate of the second liquid supplied to the second discharge nozzle, the beverage server able to adjust a concentration of the beverage dispensed from the beverage dispensing part. Note that, the “concentration” referred to here is not limited to the alcohol concentration and, for example, includes the concentration of a stock solution when diluting a liquid concentrate to prepare a beverage and all concentrations used as indicators when preparing beverages such as the sugar content and salt concentration and pH concentration when adjusting the sweetness, saltiness, acidity, flavor, etc.

Furthermore, as another aspect of the present disclosure, the beverage server may further comprise a first solenoid valve arranged at the beverage dispensing part and opening and closing the first discharge nozzle and a second solenoid valve opening and closing the second discharge nozzle, and the control device may be electrically connected to the first solenoid valve and the second solenoid valve and be configured to be able to control a time period for opening the first discharge nozzle and the second discharge nozzle.

Further, as another aspect of the present disclosure, the beverage server may further comprise an operating part electrically connected to the control device and configured to be able to set a concentration of a beverage dispensed from the beverage dispensing part.

### Advantageous Effect of Invention

According to one aspect of the present disclosure, the first liquid stored in the first tank is pumped by the first pump, runs through the first supply pipe, and is dispensed from the first discharge nozzle of the beverage dispensing part. In the middle of the first supply pipe, the first adjustment mechanism is placed and can adjust the flow rate of the first liquid supplied to the first discharge nozzle. Further, the second liquid stored in the second tank is pumped by the second pump, runs through the second supply pipe, and is dispensed from the second discharge nozzle of the beverage dispensing part. In the middle of the second supply pipe, the second adjustment mechanism is placed and can adjust the flow rate of the second liquid supplied to the second discharge nozzle. For this reason, the dispensed amounts of the beverages dispensed from the first discharge nozzle and second discharge nozzle can be adjusted.

Furthermore, according to one aspect of the present disclosure, the control device can make the first pump and the first adjustment mechanism operate together so as to control the flow rate of the first liquid supplied to the first discharge nozzle and can make the second pump and the second adjustment mechanism operate together so as to control the flow rate of the second liquid supplied to the second discharge nozzle. For this reason, for example, when making the first liquid or second liquid an alcoholic beverage and making other liquid a nonalcoholic beverage or water, it is possible to accurately customize the concentration of the beverage made by mixing the same. Further, for example, if storing a nonalcoholic beverage in the first tank or second tank and using only the first discharge nozzle or second discharge nozzle connected to this tank to dispense a beverage, it is possible to prepare a nonalcoholic beverage. Due to this, it is possible to accurately customize the concentration of beverages, including zero alcohol.

Further, according to one aspect of the present disclosure, for example, if storing an alcoholic beverage in one of the first tank and second tank and storing a nonalcoholic beverage in the other, it is possible to individually dispense the alcoholic beverage and nonalcoholic beverage from the first discharge nozzle and the second discharge nozzle. For this reason, when using just the discharge nozzle connected to the tank storing the nonalcoholic beverage to prepare a nonalcoholic beverage, it is possible to prevent or suppress contamination by alcohol.

Furthermore, according to one aspect of the present disclosure, at the beverage dispensing part, a first solenoid valve opening and closing the first discharge nozzle and a second solenoid valve opening and closing the second discharge nozzle are arranged. The control device is configured to be able to control the time period of opening the electrically connected first solenoid valve and second solenoid valve. For this reason, it is possible to accurately adjust the dispensed amounts of the first liquid and second liquid dispensed from the first discharge nozzle and second discharge nozzle and, furthermore, adjust the concentration of the beverage created by mixing the same. Due to this, it is possible to accurately customize the concentration of beverages, including zero alcohol.

Further, according to one aspect of the present disclosure, it is possible to use the operating part electrically connected to the control device to set the concentration of the beverage dispensed from the beverage dispensing part. Due to this, it is possible to accurately customize the concentration of a beverage.

### BRIEF DESCRIPTION OF DRAWINGS

FIG. 1 is a perspective view of a beverage server according to the present embodiment.

FIG. 2 is a block diagram of an internal configuration of the beverage server.

FIG. 3 is a front view of the beverage server when setting dispensing conditions.

FIG. 4 is a front view of the beverage server when selecting a beverage concentration.

### DESCRIPTION OF EMBODIMENTS

Below, referring to the attached drawings, a beverage server according to the embodiments will be explained. Similar or corresponding elements will be assigned the same notations and overlapping explanations will be omitted. To facilitate understanding, sometimes the scale of the figures will be changed for the explanation.

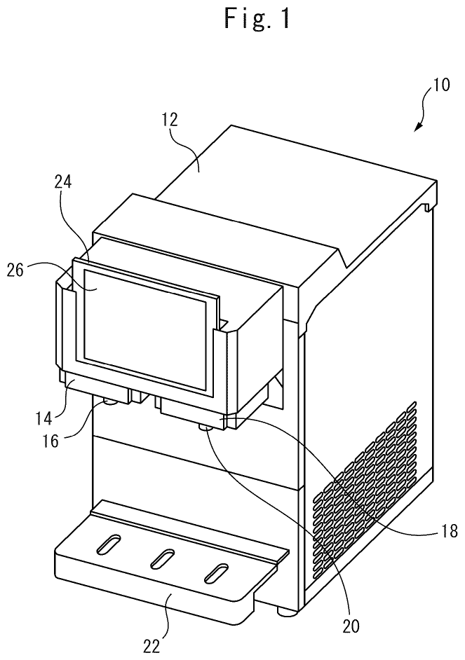

FIG. 1 shows a perspective view of a beverage server 10. At the beverage server 10, at an upper side at a front surface of a main body 12, a first beverage dispensing part 14 and second beverage dispensing part 18 are formed comprising beverage dispensing parts. The first beverage dispensing part 14 and second beverage dispensing part 18 have attached to them groups of nozzles 16, 20 for dispensing an alcoholic beverage or nonalcoholic beverage. Note that, below, as the groups of nozzles 16, 20, it was explained that pluralities of nozzles were attached, but the application is not limited to this. For example, it is also possible to have just one each centralized nozzle attached and to have different types of liquids sent from different piping mixed at the centralized nozzle right before dispensation.

The “alcoholic beverage” referred to here, for example, includes beer, alcoholic carbonated beverages other than beer, that is, low malt beer, beer flavored sparkling alcoholic beverages in which other alcoholic beverages produced from ingredients other than malt are added (so-called “third sector beer”), shochu highballs, cocktail sours, plum wine soda, spirit soda, sparkling sake, sparkling wine, high balls, and various other beverages. Further, “nonalcoholic beverage” includes nonalcoholic carbonated beverages, that is, nonalcoholic beer, nonalcoholic spirits, nonalcoholic wine, nonalcoholic sours, nonalcoholic cocktails, or carbonated juices and various other beverages. Note that, these beverages also include concentrated beverages (stock solutions).

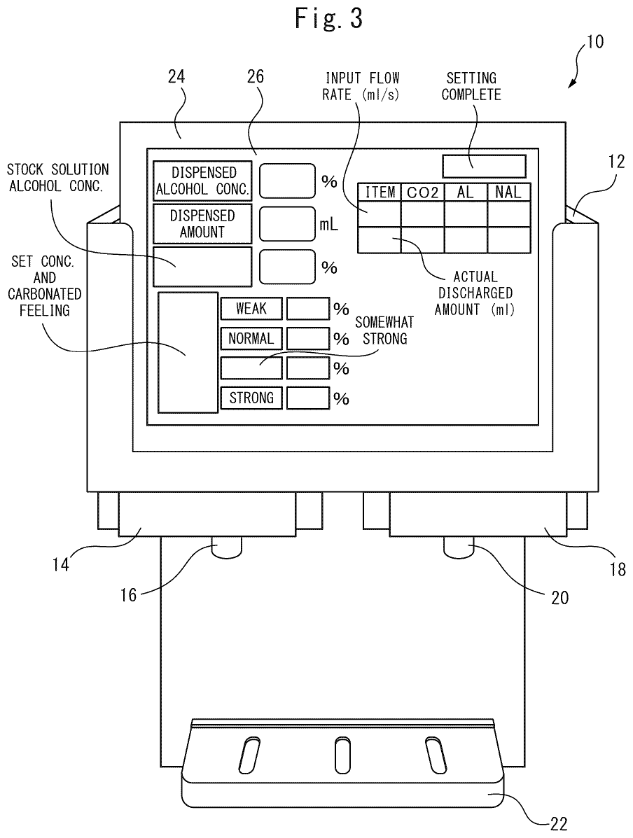

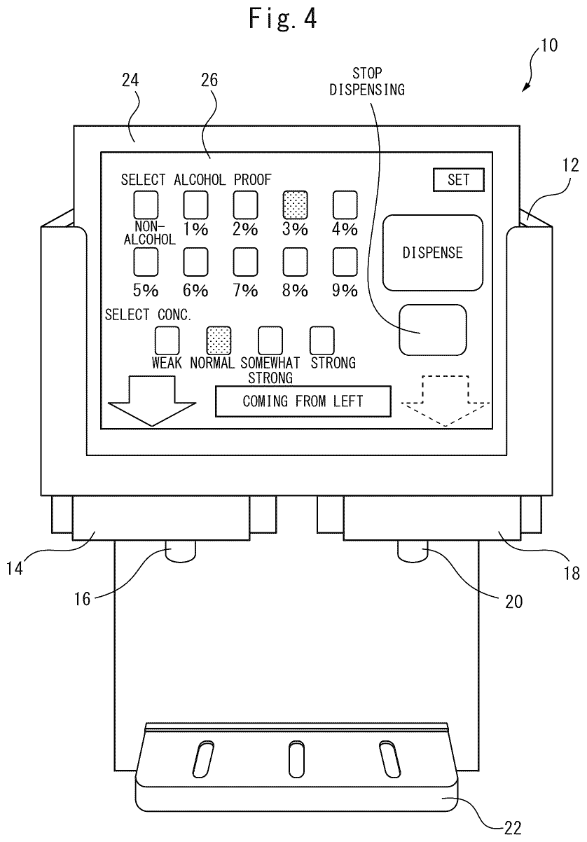

At the side below the groups of nozzles 16, 20, a receiver part 22 for placement of beverage containers (not shown) for dispensation of beverages is attached. Further, at the front side of the beverage server 10, an operating part 24 for setting the alcohol concentration of beverages dispensed is set. The operating part 24 has a touch panel 26. A user can operate the touch panel 26 to set the alcohol concentration of the beverage (see FIG. 4). Further, the operating part 24 also has the function of input and setting of the concentration of the beverage dispensed and the dispensed amount of the beverage dispensed from the groups of nozzles 16, 20. A user can operate the touch panel 26 to set the dispensed amount of the beverage (see FIG. 3).

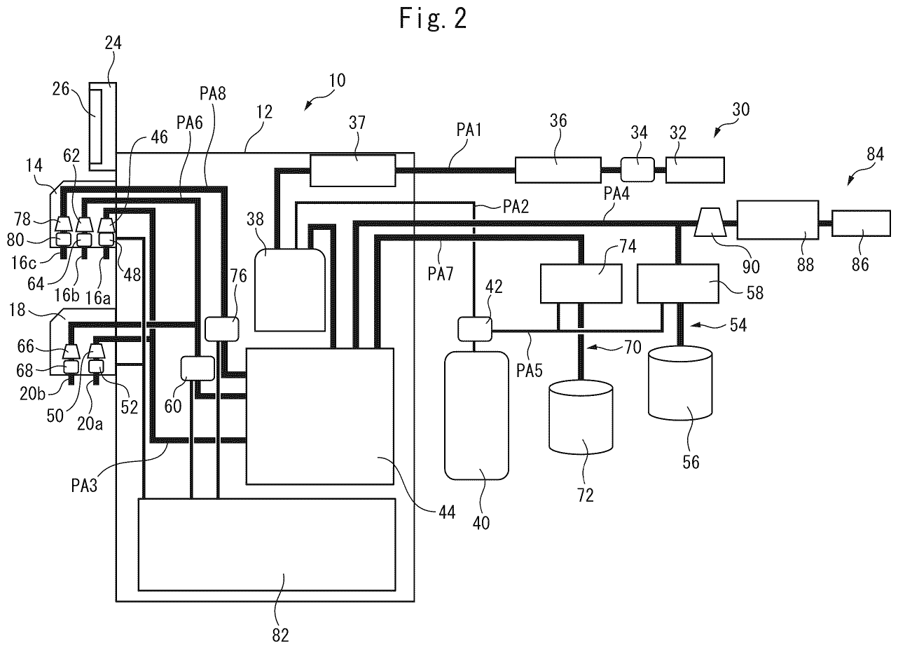

FIG. 2 is a block diagram of the beverage server 10. The beverage server 10 comprises a water supply part 30 as a third liquid supply part for supplying water as a third liquid. The water supply part 30 has a water source 32, regulator 34, and filter 36. These are connected by a back side water pipe PA1 as a third supply pipe. The back side water pipe PA1 is, for example, made of polyethylene. Note that, the application is not limited to this. It may be made by another plastic or other flexible material. The water of the water source 32 is sent, that is, flows, to a vane pump 37 arranged at the main body 12 of the beverage server 10 through the regulator 34 and filter 36. Note that, the source of the water may be a tank in which water is stored or may be the public water system supplying drinking water.

The water sent to the vane pump 37 is discharged toward a carbonator 38. The carbonator 38 is connected with a CO₂ gas tank 40 through a regulator 42 and gas pipe PA2. For this reason, by making CO₂ gas adjusted to a predetermined pressure dissolve in the water sent to the carbonator 38, carbonated water is produced. The carbonated water produced at the carbonator 38 is cooled by a cooling part 44 having a cooling coil (not shown), runs through the front side water pipe PA3 as a third supply pipe, and is sent to the first beverage dispensing part 14 and second beverage dispensing part 18. The front side water pipe PA3, for example, is made of polyethylene. Note that, the application is not limited to this. It may also be made of another plastic or other flexible material. The carbonated water sent to the first beverage dispensing part 14 can pass through the water-use solenoid valve 46 and needle valve 48 and be dispensed from the water discharge nozzle 16a as a third discharge nozzle. Further, carbonated water sent to the second beverage dispensing part 18 can pass through the water-use solenoid valve 50 and needle valve 52 and be dispensed from the water discharge nozzle 20a as a third discharge nozzle.

The beverage server 10 comprises the first beverage supply part 54 for supplying a nonalcoholic beverage as a first beverage. The first beverage supply part 54 has the first tank 56 in which the nonalcoholic beverage of the first liquid is stored and is connected with one end of the first back side supply pipe PA4 of the first supply pipe. The first back side supply pipe PA4 is, for example, made of polyethylene. Note that, the application is not limited to this. It may also be made of another plastic or other flexible material. Further, the first tank 56 is connected to a first flow jet pump 58 as the first pump. For this reason, the nonalcoholic beverage of the first tank 56 can be pumped by the first flow jet pump 58 through the first back side supply pipe PA4 toward the main body 12 side. Further, the first flow jet pump 58 is connected to the CO₂ gas tank 40 through the gas pipe PA5. For this reason, it is possible to dissolve CO₂ gas in the nonalcoholic beverage pumped toward the main body 12 side. Note that, here, the explanation was given of a nonalcoholic beverage being stored in the first tank 56, but the application is not limited to this. An alcoholic beverage may also be stored in the first tank.

The nonalcoholic beverage sent to the main body 12 is cooled by the cooling part 44, runs through the first front side supply pipe PA6 as a first supply pipe and a first flow regulator 60 as a first adjustment mechanism arranged in the middle of that, and is sent to the first beverage dispensing part 14 or second beverage dispensing part 18. The first front side supply pipe PA6 is, for example, made of polyethylene. Note that, the application is not limited to this. It may also be made of another plastic or other flexible material. The nonalcoholic beverage sent to the first beverage dispensing part 14 can pass through a solenoid valve 62 and needle valve 64 and be dispensed from a first discharge nozzle 16b. The nonalcoholic beverage sent to the second beverage dispensing part 18 can pass through a solenoid valve 66 and needle valve 68 and be dispensed from a first discharge nozzle 20b.

The beverage server 10 is, further, comprises a second beverage supply part 70 for supplying an alcoholic beverage as a second beverage. The second beverage supply part 70 has a second tank 72 in which an alcoholic beverage as a second liquid set to a predetermined alcohol concentration is stored and is connected to one end part of a second back side supply pipe PA7 as a second supply pipe. The second back side supply pipe PA7 is, for example, made of polyethylene. Note that, the application is not limited to this. It may also be made of another plastic or other flexible material. Further, the second tank 72 is connected to a second flow jet pump 74 as a second pump. For this reason, the alcoholic beverage of the second tank 72 can be pumped by the second flow jet pump 74 through the second back side supply pipe PA7 to the main body 12 side. Further, the second flow jet pump 74 is connected with the CO₂ gas tank 40 through the gas pipe PA5. For this reason, CO₂ gas can be dissolved in the alcoholic beverage pumped toward the main body 12 side. Note that, here, the explanation was given assuming an alcoholic beverage was stored in the second tank 72, but the application is not limited to this. A nonalcoholic beverage may also be stored in the second tank.

The alcoholic beverage sent to the main body 12 is cooled by the cooling part 44, runs through a second front side supply pipe PA8 as a second supply pipe and a second flow regulator 76 as a second adjustment mechanism arranged in the middle of that, and is sent to the first beverage dispensing part 14. The second front side supply pipe PA8 is, for example, made of polyethylene. Note that, the application is not limited to this. It may also be made of another plastic or other flexible material. The alcoholic beverage sent to the first beverage dispensing part 14 can pass through a second solenoid valve 78 and needle valve 80 and be dispensed from the second discharge nozzle 16c.

At the lower side of the main body 12, a control device 82 is arranged. The control device 82 is electrically connected with the first flow jet pump 58 and second flow jet pump 74 and is configured to be able the change their discharge rates. Further, the control device 82 is electrically connected with the first flow regulator 60 and second flow regulator 76 and is configured to be able to operate these to enlarge or constrict the flow paths and thereby change the flow rates of the beverages passing through them. For this reason, the control device 82 can adjust the flow rates of the beverages passing through the first flow regulator 60 and second flow regulator 76 in accordance with the discharge rates of the operated first flow jet pump 58 and second flow jet pump 74. Due to this, it is possible to accurately adjust the concentrations of the beverages prepared by the beverages and carbonated water dispensed from the groups of nozzles 16, 20. Note that, the first flow regulator and second flow regulator may comprise flow meters or flow sensors. The control device may be configured to operate the first flow regulator and second flow regulator in accordance with the actually measured values of the flow rates at the first flow regulator and second flow regulator.

Note that, here, the explanation is given assuming adjustment of the flow rates of the beverages running through the first flow regulator 60 and second flow regulator 76 in accordance with the discharge rates of the first flow jet pump 58 and second flow jet pump 74, but the application is not limited to this. For example, it is also possible to make the discharge rates of the first flow jet pump and second flow jet pump fixed and set operating conditions in accordance with the dispensed amounts of beverages of the first flow regulator and second flow regulator in advance in the control device or to set enlargement or constriction of the flow paths of the first flow regulator and second flow regulator manually in accordance with the dispensed amounts of the beverages.

Furthermore, the control device 82 is electrically connected to the solenoid valves 46, 50, 62, 66, 78 attached to the groups of nozzles 16, 20 and can operate them while setting their open time periods. For this reason, the control device 82 can accurately adjust the discharge rates of beverages and carbonated water from the groups of nozzles 16, 20.

The control device 82 is electrically connected to the operating part 24 as well. For this reason, it is possible to control the discharge rates of the first flow jet pump 58 and second flow jet pump 74, the enlargement or constriction of the flow paths of the first flow regulator 60 and second flow regulator 76, and the opening and closing of the solenoid valves 46, 50, 62, 66, 78 in accordance with the dispensed amount and concentration of the beverage input from the operating part 24.

The first beverage supply part 54 supplying the nonalcoholic beverage comprises a washing mechanism 84 for washing the first beverage supply part 54. The washing mechanism 84 is connected to the first back side supply pipe PA4 through a solenoid valve 90. At the time of washing, the solenoid valve 90 can be opened and a washing use flow jet pump 88 used to run the water in a water tank 86 to the water discharge nozzles 16a, 20a. Due to this, it is possible to easily wash the first beverage supply part 54 supplying the nonalcoholic beverage. Note that, here, the washing mechanism 84 was explained as being provided at the first beverage supply part 54, but the application is not limited to this. The washing mechanism may also be provided at the second beverage supply part. Further, instead of the water tank 86, the public water supply system may also be used.

FIG. 3 shows the operating part 24 when setting the dispensing conditions. A user can input the concentration of the alcoholic beverage stored in the second tank 72 (“STOCK SOLUTION ALCOHOL CONC.” on the touch panel 26) and can input the dispensed amount of the beverage to be dispensed from the groups of nozzles 16, 20 (“DISPENSED AMOUNT” of the touch panel 26). Further, the user can input and set the concentration and carbonated feel of the beverage at the time of selection of the beverage concentration explained later (“WEAK”, “NORMAL”, “SOMEWHAT STRONG”, “STRONG” of the touch panel 26). Further, the user can switch to the beverage concentration selection screen (see FIG. 4) by pressing “SETTING COMPLETE” on the touch panel 26 if setting the dispensing conditions.

FIG. 4 shows the operating part 24 at the time of selection of the beverage concentration. A user can select the alcohol concentration of the beverage to be dispensed from the groups of nozzles 16, 20 (“SELECT ALCOHOL PROOF” of the touch panel 26) or the concentration and carbonated feel of the beverage (“SELECT CONCENTRATION” of the touch panel 26). The user selecting the concentration can press “DISPENSE” on the touch panel 26 to make the beverage be dispensed from the groups of nozzles 16, 20.

Next, the action and effects of the beverage server 10 according to the present embodiment will be explained below.

According to the beverage server 10 according to the present embodiment, a nonalcoholic beverage stored in the first tank 56 is pumped by the first flow jet pump 58 and passes through the first supply pipes PA4, PA6 to be dispensed from the first discharge nozzles 16b, 20b of the beverage dispensing parts 14, 18. Further, the alcoholic beverage stored in the second tank 72 is pumped by the second flow jet pump 74 and passes through second supply pipes PA7, PA8 to be dispensed from the second discharge nozzle 16c of the beverage dispensing part 14, 18. Furthermore, the water supplied from the water supply part 30 passes through the water pipes PA1, PA3 to be dispensed from the water discharge nozzles 16a, 20a of the beverage dispensing parts 14, 18. In the middle of the first supply pipes PA4, PA6, the first flow regulator 60 is arranged and can adjust the flow rate of the nonalcoholic beverage supplied to the first discharge nozzles 16b, 20b. For this reason, it is possible to adjust the concentration of the nonalcoholic beverage prepared by mixing the nonalcoholic beverage dispensed from the first discharge nozzles 16b, 20b and the water dispensed from the water discharge nozzles 16a, 20a. Further, in the middle of the second supply pipes PA7, PA8, the second flow regulator 76 is arranged and can adjust the flow rate of the alcoholic beverage supplied to the second discharge nozzle 16c. For this reason, it is possible to adjust the concentration of the alcoholic beverage prepared by mixing the alcoholic beverage dispensed from the second discharge nozzle 16c and the nonalcoholic beverage and water dispensed from the first discharge nozzle 16b and water discharge nozzle 16a. Due to this, it is possible to accurately customize the alcohol concentration, including zero alcohol, of a beverage.

Furthermore, according to the beverage server 10 according to the present embodiment, it is possible to individually dispense a nonalcoholic beverage and alcoholic beverage from the first discharge nozzles 16b, 20b and second discharge nozzle 16c, so when preparing a nonalcoholic beverage, it is possible to prevent or suppress contamination by alcohol.

Further, according to the beverage server 10 according to the present embodiment, the first flow jet pump 58 and the first flow regulator 60 can be made to operate together by the control device 82. For this reason, it is possible to make the first flow regulator 60 operate in accordance with the amount of nonalcoholic beverage pumped by the first flow jet pump 58 and adjust the flow rate of the nonalcoholic beverage supplied to the first discharge nozzles 16b, 20b. Further, the second flow jet pump 74 and second flow regulator 76 can be made to operate together by the control device 82. For this reason, it is possible to make the second flow regulator 76 operate in accordance with the amount of alcoholic beverage pumped by the second flow jet pump 74 and adjust the flow rate of the alcoholic beverage supplied to the second discharge nozzle 16c. Due to this, it is possible to accurately customize the alcohol concentration, including zero alcohol, of a beverage.

Furthermore, according to the beverage server 10 according to the present embodiment, at the beverage dispensing parts 14, 18, water use solenoid valves 46, 50 for opening and closing the water discharge nozzles 16a, 20a, first solenoid valves 62, 66 for opening and closing the first discharge nozzles 16b, 20b, and a second solenoid valve 78 for opening and closing the second discharge nozzle 16c are arranged. The control device 82 is configured to be able to control the time period of opening the electrically connected water use solenoid valves 46, 50, first solenoid valves 62, 66, and second solenoid valve 78. For this reason, it is possible to dispense water from the water discharge nozzles 16a, 20a in exactly the accurate amounts and to dispense the nonalcoholic beverage and alcoholic beverage from the first discharge nozzles 16b, 20b and second discharge nozzle 16c in exactly the accurate amounts. Due to this, it is possible to accurately customize the alcohol concentration, including zero alcohol, of a beverage.

Further, according to the beverage server 10 according to the present embodiment, it is possible to set the alcohol concentration of the beverage dispensed from the beverage dispensing parts 14, 18 in the operating part 24 electrically connected to the control device 82. Due to this, it is possible to accurately customize the alcohol concentration, including zero alcohol, of a beverage.

As explained above, according to the beverage server 10 according to the present embodiment, it is possible to accurately customize the concentration of a nonalcoholic beverage and alcoholic beverage.

Note that, here, the beverage server 10 was explained as comprising a water supply part 30 as a third liquid supply part for supplying water as a third liquid, but the application is not limited to this. For example, the third liquid dispensed from the third discharge nozzle may also be made an alcoholic beverage or nonalcoholic beverage. As the third liquid supply part for this, a tank storing an alcoholic beverage or nonalcoholic beverage may be provided.

Further, here, the beverage server 10 was explained as comprising a CO₂ gas tank 40, but the application is not limited to this. The beverage server may also not be provided with a CO₂ gas tank but be configured to dispense just noncarbonated beverages.

Furthermore, here, the explanation was given assuming adjustment of the alcohol concentration, including no alcohol, by the beverage server 10, but the application is not limited to this, Note that, the beverage server may also be configured to adjust the concentration of a stock solution when diluting a liquid stock solution to prepare a beverage and all concentrations used as indicators when preparing beverages such as the sugar content and salt concentration and pH concentration when adjusting the sweetness, saltiness, acidity, flavor, etc.

Above, embodiments of the beverage server 10 were explained, but the present application is not limited to the above embodiments. It is believed that a person skilled in the art could make various modifications to the above embodiments.

### REFERENCE SIGNS LIST

10 beverage server
14 first beverage dispensing part (beverage dispensing part)
16a water discharge nozzle (third discharge nozzle)
16b first discharge nozzle
16c second discharge nozzle
18 second beverage dispensing part (beverage dispensing part)
20a water discharge nozzle (third discharge nozzle)
20b first discharge nozzle
24 operating part
30 water supply part (third liquid supply part)
56 first tank
58 first flow jet pump (first pump)
60 first flow regulator (first adjustment mechanism)
62 first solenoid valve
66 first solenoid valve
72 second tank
74 second flow jet pump (second pump)
76 second flow regulator (second adjustment mechanism)
78 second solenoid valve
82 control device
PA1 back side water pipe (third supply pipe)
PA3 front side water pipe (third supply pipe)
PA4 first back side supply pipe (first supply pipe)
PA6 first front side supply pipe (first supply pipe)
PA7 second back side supply pipe (second supply pipe)
PA8 second front side supply pipe (second supply pipe)

1. A beverage server for providing a beverage, the beverage server comprising
a beverage dispensing part having at least one of a first discharge nozzle and a second discharge nozzle among a first discharge nozzle, second discharge nozzle, and third discharge nozzle and dispensing a beverage,
a first pump connected with a first tank and pumping a first liquid stored in the first tank,
a first supply pipe connecting the first tank and the first discharge nozzle and having the first liquid pumped from the first tank flowing through it,
a first adjustment mechanism arranged in the middle of the first supply pipe and able to adjust a flow rate of the first liquid supplied to the first discharge nozzle,
a second pump connected with a second tank and pumping a second liquid stored in the second tank,
a second supply pipe connecting the second tank and the second discharge nozzle and having the second liquid pumped from the second tank flowing through it,
a second adjustment mechanism arranged in the middle of the second supply pipe and able to adjust a flow rate of the second liquid supplied to the second discharge nozzle,
a third supply pipe connecting a third liquid supply part for supplying a third liquid and a third discharge nozzle and having the third liquid from the third liquid supply part flowing through it, and
a control device making the first pump and the first adjustment mechanism operate together so as to enable control of a discharge rate of the first liquid supplied to the first discharge nozzle and making the second pump and the second adjustment mechanism operate together so as to enable control of a discharge amount of the second liquid supplied to the second discharge nozzle,
the beverage server able to adjust a concentration of the beverage dispensed from the beverage dispensing part.

2. The beverage server according to claim 1,
further comprising a first solenoid valve arranged at the beverage dispensing part and opening and closing the first discharge nozzle and a second solenoid valve opening and closing the second discharge nozzle,
the control device being electrically connected to the first solenoid valve and the second solenoid valve and being configured to be able to control a time period for opening the first discharge nozzle and the second discharge nozzle.

3. The beverage server according to claim 1, further comprising an operating part electrically connected to the control device and configured to be able to set a concentration of a beverage dispensed from the beverage dispensing part.
